(19) United States
(12) Patent Application Publication
(10) Pub. No.: US 2025/0223160 A1
(43) Pub. Date: Jul. 10, 2025

(54) PROCESS FOR PRODUCING HYDROGEN

(71) Applicant: JOHNSON MATTHEY PUBLIC LIMITED COMPANY, London (GB)

(72) Inventors: Paul John CASSIDY, London (GB); Robert CHRISTIE, London (GB); Phillip David EVANS, Stockton-On-Tees (GB); Neil David YORATH, London (GB)

(21) Appl. No.: 18/851,508

(22) PCT Filed: Jun. 9, 2023
(86) PCT No.: PCT/GB2023/051507

§ 371 Date: Sep. 26, 2024

(30) Foreign Application Priority Data
Jun. 15, 2022 (GB) 2208800.9

(51) Int. Cl. C01B 3/48; C01B 3/38

(52) U.S. Cl. CPC C01B 3/48; C01B 3/382; C01B 2203/0233; C01B 2203/0244; C01B 2203/0255; C01B 2203/0288; C01B 2203/0405; C01B 2203/043; C01B 2203/0475; C01B 2203/0816; C01B 2203/0894; C01B 2203/1058; C01B 2203/1235; C01B 2203/141; C01B 2203/142; C01B 2203/147

(57) ABSTRACT

A process for producing hydrogen comprising the steps of reforming a hydrocarbon feedstock to form a synthesis gas; subjecting the synthesis gas to one or more stages of water gas shift to convert carbon monoxide to carbon dioxide and form a hydrogen-enriched synthesis gas; and treating the hydrogen-enriched synthesis gas to form a purified hydrogen product and tail gas stream containing methane, wherein at least a portion of the tail gas stream is treated by subjecting it to partial oxidation or autothermal reforming to form a partially-oxidised or reformed tail gas, followed by of water gas shift of the partially-oxidised or reformed tail gas to form a hydrogen-enriched tail gas, and a step of carbon dioxide removal from the hydrogen-enriched tail gas to form a hydrogen stream and a carbon dioxide stream, wherein the carbon dioxide stream is recovered and a portion of the hydrogen stream is a fuel.

### TECHNICAL FIELD

This invention relates to a process for producing hydrogen, in particular a process for producing hydrogen with low emissions of carbon dioxide from the process.

### BACKGROUND TO THE INVENTION

Hydrogen is generally produced from hydrocarbons such as natural gas by steam reforming, to generate a synthesis gas containing hydrogen, carbon monoxide and carbon dioxide (CO₂) that is further processed to provide a purified hydrogen product. Steam reforming of hydrocarbons using fired steam reformers generates large volumes of carbon-dioxide-containing flue gases that are challenging to process efficiently for CO₂ capture.

Many H₂ plants today include an arrangement in which the following stages are carried out sequentially: steam reforming in a steam methane reformer (SMR), water-gas shift and H₂ separation to generate a H₂ product stream and a tail-gas stream. The tail-gas or alternatively a portion of the H₂ product may be used as fuel for the SMR.

US2010/310949A1 discloses a process for producing a hydrogen-containing product gas with reduced carbon dioxide emissions compared to conventional hydrogen production processes. A hydrocarbon and steam are reformed in a reformer and the resulting reformate stream is shifted in one or more shift reactors. The shifted mixture is scrubbed to remove carbon dioxide to form a carbon dioxide-depleted stream. The carbon dioxide-depleted stream is separated to form a hydrogen-containing product gas and a by-product gas. A portion of the hydrogen containing product gas is used as a fuel in the reformer and a portion of the by-product gas is recycled back into the process. The process may optionally include reforming in a prereformer and/or an oxygen secondary reformer. Recycling carbon to the process in this way has advantages, but there is a need to more efficiently reduce the CO₂ emissions from hydrogen processes using fired steam reformers and to retrofit existing processes.

US2011/0104045A1 discloses a method of hydrogen production comprising: producing a syngas stream in a steam methane reformer (SMR), removing CO₂ from said syngas in a CO₂ removal unit thereby producing a CO₂ depleted syngas stream, and removing H₂ from said CO₂ depleted syngas stream in a pressure swing adsorption (PSA) unit to produce a residue fuel stream. The residue fuel stream is combined with make-up fuel to produce a blended fuel stream, which is treated in a series of steps including LP reforming and CO₂ removal in a PSA unit to generate a reformer fuel stream which is used as fuel for the SMR.

Although processes are known for the production of H₂ with low CO₂ emissions, they are generally contemplated for grassroots H₂ plants. There is a need for technologies which can be retrofitted to existing H₂ plants in order to reduce their CO₂ emissions. The present invention addresses this need.

### SUMMARY OF THE INVENTION

In one aspect the invention relates to method for retrofitting a hydrogen production unit comprising:
a hydrocarbon reforming unit comprising a fired steam reformer arranged to be fed with a hydrocarbon feedstock;
a synthesis gas water gas shift unit arranged to be fed with a synthesis gas from the hydrocarbon reforming unit to produce a hydrogen-enriched synthesis gas; and
a purification unit arranged to be fed with a hydrogen-enriched synthesis gas from the synthesis gas water gas shift unit to generate a hydrogen product and a tail gas stream:
the method comprising installing a tail gas treatment unit comprising:
a partial oxidation reactor or a tail gas reforming unit arranged to accept at least a portion of the tail gas stream from the purification unit and produce a partially-oxidised or reformed tail gas stream;
a tail gas water-gas shift unit arranged to accept a partially-oxidised or reformed tail gas stream from the partial oxidation reactor or a tail gas reforming unit and produce to form a hydrogen-enriched tail gas stream;
a tail gas carbon dioxide removal unit arranged to accept a hydrogen-enriched tail gas stream from the tail gas water-gas shift unit and produce a hydrogen stream,
wherein the tail gas treatment unit is arranged to feed the hydrogen stream to the fired steam reformer as a fuel.

Together, the partial oxidation reactor or tail gas reforming unit, the tail gas water gas shift unit and the tail gas carbon dioxide removal unit may be described as a tail gas treatment unit. The use or installation of a tail gas treatment unit according to the present invention offer operators a means to significantly decarbonise the hydrogen process by replacing a carbon containing fuel with a hydrogen fuel for the fired steam reformer. The hydrogen fuel may also be used in place of natural gas in any fired heaters used in the process or the tail gas treatment unit to preheat feeds or generate steam for the process.

In another aspect the invention relates to a process for producing hydrogen comprising the steps of:
(i) reforming a hydrocarbon feedstock in a hydrocarbon reforming unit comprising a fired steam reformer to form a synthesis gas containing hydrogen, carbon monoxide and carbon dioxide;
(ii) subjecting the synthesis gas to one or more stages of water gas shift in a synthesis gas water gas shift unit to convert carbon monoxide to carbon dioxide and form a hydrogen-enriched synthesis gas; and
(iii) treating the hydrogen-enriched synthesis gas in a purification unit to form a purified hydrogen product and tail gas stream containing methane,
wherein at least a portion of the tail gas stream is treated in a tail gas treatment unit by subjecting it to:
partial oxidation in a partial oxidation reactor or autothermal reforming in a tail gas reforming unit to form a partially-oxidised or reformed tail gas, followed by
one or more stages of water gas shift of the partially-oxidised or reformed tail gas in a tail gas water-gas shift unit to form a hydrogen-enriched tail gas, and
a step of carbon dioxide removal from the hydrogen-enriched tail gas in a tail gas carbon dioxide removal unit to form a hydrogen stream and a carbon dioxide stream,
wherein the carbon dioxide stream is recovered and a portion of the hydrogen stream is fed to the fired steam reformer as a fuel.

This process may be established in a new hydrogen production unit, or an existing hydrogen production unit retrofitted according to the first aspect.

### DETAILED DESCRIPTION

Sub-headings are included for convenience but are not intended to limit the disclosure in any way.

### Hydrocarbon Feed to Hydrocarbon Reforming Unit

The hydrocarbon feed may be any gaseous or low boiling hydrocarbon, such as natural gas, associated gas, LPG, petroleum distillate, diesel, naphtha or mixtures thereof, or hydrocarbon-containing off-gases from chemical processes, such as a refinery off-gas or a pre-reformed gas containing methane. The gaseous mixture preferably comprises methane, associated gas or natural gas containing a substantial proportion, e.g. over 50% by volume methane. Natural gas is especially preferred. The hydrocarbon may be compressed to a pressure in the range 10-100 bar abs.

If the hydrocarbon feedstock contains sulphur compounds, before or after compression, the feedstock is preferably subjected to desulphurisation, e.g. hydrodesulphurisation using Co or Ni catalysts and absorption of hydrogen sulphide using a suitable absorbent, e.g. a zinc oxide bed. To facilitate this hydrogen is preferably added to the hydrocarbon feedstock. The amount of hydrogen in the resulting mixed gas stream may be in the range 1-20% vol, but is preferably in the range 1-10%, more preferably in the range 1-5%. In a preferred embodiment a portion of the purified hydrogen, or a portion of the hydrogen stream from the tail gas treatment unit, if the nitrogen level is below 0.1% by volume, is mixed with the hydrocarbon feed stream. The hydrogen may be combined with the hydrocarbon upstream of any hydrodesulphurisation stage. The resulting desulphurised hydrocarbon feedstock may also be fed to the tail gas treatment unit.

If the hydrocarbon feedstock contains other contaminants, such as chloride or heavy metal contaminants, these may be removed, prior to reforming, upstream or downstream of any desulphurisation, using conventional adsorbents. Adsorbents suitable for chloride removal are known and include alkalised alumina materials. Similarly, adsorbents for heavy metals such as mercury or arsenic are known and include copper sulphide materials.

The hydrocarbon feedstock is subjected to steam reforming in the hydrocarbon reforming unit. In steam reforming, the hydrocarbon feedstock is mixed with steam: this steam introduction may be performed by direct injection of steam and/or by saturation of the hydrocarbon feedstock by contact of the latter with a stream of heated water in a saturator. If desired, a portion of the hydrocarbon feedstock may bypass the steam addition, e.g. the saturator. The amount of steam introduced may be such as to give a steam to carbon ratio at the inlet to the fired steam reformer of 1.5 to 5, preferably about 3, i.e. 3 moles of steam per gram atom of hydrocarbon carbon in the hydrocarbon feedstock.

Where the hydrocarbon is a rich natural gas, naphtha or other hydrocarbon-containing feedstock containing hydrocarbons heavier than methane it may be desirable to subject it to a step of pre-reforming upstream of the fired steam reformer and/or the tail gas treatment unit. Pre-reforming processes are known. In such processes, the hydrocarbon/steam mixture is heated, typically to a temperature in the range 400 to 650° C., and then passed adiabatically through a fixed bed of a suitable particulate steam reforming catalyst, usually a precipitated catalyst having a high nickel content, for example above 40% by weight, expressed as NiO. During such an adiabatic reforming step, any hydrocarbons higher than methane react with steam to give a pre-reformed gas comprising a mixture of methane, carbon oxides and hydrogen. The use of pre-reforming step is desirable to ensure that the feed to the fired steam reformer contains no hydrocarbons higher than methane and also contains a significant amount of hydrogen. This is desirable in order to minimise the risk of carbon formation on the catalyst in the fired steam reformer.

The hydrocarbon/steam mixture is desirably pre-heated prior to reforming in the fired steam reformer. This may be achieved by passing the feed though heat exchange coils in a convection section of the fired steam reformer, and/or by using a fired heater. If a fired heater is used, then it is preferably heated by combustion of a portion of the hydrogen stream. Desirably, the mixed stream is heated to an inlet temperature in the range 300 to 650° C. Inlet temperatures in the range of 300 to 550° C. are particularly suitable when there is no pre-reformer and higher inlet temperatures in the range of 550 to 650° C. are particularly suitable when there is a pre-reformer.

### Hydrocarbon Reforming Unit

The hydrocarbon feedstock/steam gas mixture is then subjected to reforming in the hydrocarbon reforming unit comprising a fired steam reformer, which may also be termed a fired steam reformer, or a fired catalytic steam reformer because steam is used to convert the hydrocarbon feedstock into synthesis gas over a catalyst. The catalyst may be any suitable steam reforming catalyst, for example 3-30% wt nickel catalysts supported on a refractory oxide in the form of pellets or provided as a wash coat on a structured metal or ceramic catalyst support. Fired steam reformers are known and generally comprise a radiant section containing a plurality of catalyst-containing reformer tubes through which the mixture of hydrocarbon feedstock and steam is passed. The reformer tubes are typically arranged vertically in rows. Fuel and air are fed to a plurality of burners in the walls of the radiant section of the fired steam reformer that combust the fuel to generate heat for the endothermic steam reforming reactions. The fired steam reformer may be a side-fired reformer or a top-fired reformer. The combustion gas is typically then conveyed through a downstream convection section of the fired steam reformer where it may be used to heat feed streams and/or generate steam, before being discharged as a flue gas.

During the reforming process, methane reacts with steam over the catalyst to produce a synthesis gas comprising hydrogen, carbon monoxide and carbon dioxide. Any hydrocarbons containing two or more carbon atoms that are present are converted to methane, carbon monoxide and hydrogen. In addition, water-gas shift reactions occur. Overall, the process is endothermic, requiring heating of the tubes and catalyst to maintain the reaction and achieve the desired conversion. The heat input to the steam reformer is typically such that the temperature of product gas stream at the outlet of the tubes is higher than the inlet temperature, often in the range of 100 to 350 degrees Celsius higher than the inlet temperature. The fired steam reformer may be operated with a relatively high exit temperatures, e.g. above 850° C., such that the methane content of the synthesis gas is low, but in some arrangements the exit temperature may be lower, e.g. in the range 700-850° C., and in consequence the fuel demand reduced, where a secondary reformer is included in the hydrocarbon reforming unit downstream of the fired, or primary, reformer. The secondary reformer is preferably an autothermal reformer. Accordingly in some arrangements, the reforming unit comprises a fired steam reformer and an autothermal reformer. The reformed gas from the fired steam reformer is fed to the autothermal reformer to convert residual methane in the primary reformed gas into synthesis gas. In a preferred arrangement, the autothermal reformer may also be fed with a portion of the hydrocarbon feedstock to increase the synthesis gas production. In this arrangement the reformed gas from the fired steam reformer is mixed with a portion of the hydrocarbon feedstock. The portion of the total hydrocarbon feedstock that is fed to the autothermal reformer may be in the range 5-60% by volume, or 60-95% by volume or 33-70% by volume. Such combined reforming is known and is described, for example, in U.S. Pat. No. 4,888,130A.

The autothermal reformer will generally comprise a burner disposed near the top of the reformer, to which is fed the primary reformed gas mixture and an oxygen-containing gas, a combustion zone beneath the burner through which, typically, a flame extends, above a fixed bed of a particulate steam reforming catalyst. In autothermal or secondary reforming, the heat for the endothermic steam reforming reactions is provided by combustion of hydrocarbon and hydrogen in the feed gas. The reformed gas mixture from the fired steam reformer is typically fed to the top of the autothermal reformer and the oxygen-containing gas fed to the burner, mixing and combustion occur downstream of the burner generating a heated gas mixture which is brought to equilibrium as it passes through the steam reforming catalyst. If desired steam may be added to the oxygen containing gas. The autothermal reforming catalyst is usually nickel, e.g. at 3-30% wt, supported on a refractory support such as rings or pellets of calcium aluminate cement, alumina, titanium dioxide, zirconium dioxide and the like. In a preferred embodiment, the secondary reforming catalyst comprises a layer of a higher activity Ni and/or Rh on zirconium dioxide catalyst over a conventional Ni on alumina catalyst to reduce catalyst support volatilisation.

The oxygen-containing gas used in the autothermal reformer of the hydrocarbon reforming unit preferably comprises ≥95% vol. O₂, which may be provided by an air separation unit (ASU) or from another oxygen source. Preferably the O₂ content is ≥98% vol or ≥99% vol. The amount of oxygen-containing gas required in the autothermal reformer is determined by the desired composition of the product gas. In general, increasing the amount of oxygen, thereby increasing the temperature of the reformed gas leaving the autothermal reformer, causes the [H₂]/[CO] ratio to decrease and the proportion of carbon dioxide to decrease. Preferably, the amount of oxygen added is such that the autothermally reformed gas leaves the autothermal reforming catalyst at a temperature in the range 750-1050° C. The autothermally-reformed gas recovered from the autothermal reformer is a synthesis gas comprising hydrogen, carbon monoxide, carbon dioxide, methane and steam. The amount of methane is influenced by the autothermal reformer exit temperature.

The hydrocarbon reforming unit produces a synthesis gas containing hydrogen, carbon monoxide, carbon dioxide and steam.

After leaving the hydrocarbon reforming unit the synthesis gas is then desirably cooled in one or more steps of heat exchange, generally including at least a first stage of steam raising. The temperature is preferably adjusted to the inlet temperature for the synthesis gas water gas shift unit.

It is preferred that the outlet gases from the ATR are cooled to generate superheated steam. The superheated steam is then used to generate electricity, for example by expanding the superheated steam using a steam turbine with a connected alternator. This arrangement reduces the electricity import to the process.

### Synthesis Gas Water-Gas Shift

The synthesis gas produced by the hydrocarbon reforming unit is subjected to one or more stages of water-gas shift in a synthesis gas water gas shift unit. Steam is necessary for the water-gas shift reaction. If insufficient steam is present in the synthesis gas, steam may be added upstream of the synthesis water gas shift unit, e.g. by direct addition.

The synthesis gas may be passed through one or more beds of water-gas shift catalyst in one or more shift vessels to generate a hydrogen-enriched, or “shifted”, gas. At the same time the water gas shift unit converts carbon monoxide in the synthesis gas to carbon dioxide. The reaction may be depicted as follows;

CO+H₂O [symbol] CO₂+H₂

The one or more water-gas shift stages may include stages of high-temperature shift, medium-temperature shift, isothermal shift and low-temperature shift. One or more adiabatic water-gas shift stages may be employed, such as a high-temperature shift stage, optionally followed by a low-temperature shift stage.

High-temperature shift may be operated adiabatically in a shift vessel at inlet temperatures in the range 300-400° C., preferably 320-360° C., over a bed of a reduced iron catalyst, such as chromia-promoted magnetite. Alternatively, a potassium promoted zinc-aluminate catalyst may be used. A single stage of high-temperature shift may be used in the present invention. Alternatively, a combination of high-temperature and medium-temperature or low-temperature shift may be used.

Medium-temperature shift and low-temperature shift stages may be performed using shift vessels containing supported copper-catalysts, particularly copper/zinc oxide/alumina compositions. In low-temperature shift, a gas containing carbon monoxide (preferably ≤6% vol CO on a dry basis) and steam (at a steam to total dry gas molar ratio in range 0.3 to 1.5) may be passed over the catalyst in an adiabatic fixed bed with an outlet temperature in the range 200 to 300° C. The outlet carbon monoxide content may be in the range 0.1 to 1.5%, especially under 0.5% vol on a dry basis if additional steam is added. Alternatively, in medium-temperature shift, the gas containing carbon monoxide and steam may be fed to the catalyst at an inlet temperature in the range 200 to 240° C. although the inlet temperature may be as high as 280° C. The outlet temperature may be up to 300° C. but may be as high as 360° C.

In preferred embodiments the water gas shift unit includes a high temperature shift vessel.

In another preferred embodiment the water gas shift unit includes a high temperature shift vessel and a low temperature shift vessel.

Following the one or more shift stages, the hydrogen-enriched synthesis gas is desirably cooled to a temperature below the dew point and condensate separated from it upstream of the purification unit. This forms a de-watered hydrogen-enriched synthesis gas. The liquid water condensate may then be separated using one or more, gas-liquid separators, which may have one or more further cooling stages between them. Any coolant may be used. Typically cooling of the hydrogen-enriched synthesis gas may be provided by boiling water under pressure coupled to a steam drum. If desired, cooling may be carried out in heat exchange with the process condensate. As a result, a stream of heated water, which may be used to supply some or all of the steam required for reforming in the hydrocarbon reforming unit and/or the tail gas reforming unit, may be formed. Because the condensate may contain ammonia, methanol, hydrogen cyanide and CO₂, returning the condensate to form steam used in the reforming stages offers a useful way of returning hydrogen and carbon to the process. One or more further stages of cooling are desirable. The cooling may be performed in heat exchange in one or more stages using demineralised water, air, or a combination of these. One, two or three stages of condensate separation may be performed. Any condensate not used to generate steam may be sent to water treatment as effluent.

The hydrogen-enriched synthesis gas, or the de-watered hydrogen-enriched synthesis gas, is subjected to treatment in a purification unit to produce a purified hydrogen product and a tail gas stream.

### CO₂ Removal

Typically, the hydrogen-enriched synthesis gas stream contains 10 to 30% vol of carbon dioxide (on a dry basis). Therefore, optionally, after separation of the condensed water, carbon dioxide may be separated from the hydrogen-enriched synthesis gas stream in a synthesis gas carbon dioxide removal unit upstream of the purification unit. Thus, in some arrangements the process may include optionally recovering carbon dioxide from the hydrogen enriched synthesis gas using a carbon dioxide removal unit, for example by washing the hydrogen-enriched synthesis gas using a physical or reactive liquid absorbent, to form a crude hydrogen stream, and then feeding the crude hydrogen stream to the purification unit.

Similarly, the retrofitting method may therefore include installing a synthesis gas carbon dioxide removal unit between the synthesis gas water gas shift unit and the purification unit, to remove some carbon dioxide from the hydrogen-enriched synthesis gas and so reduce the burden on the purification unit. The synthesis gas carbon dioxide removal unit may be the same as that set out below for use in the tail gas carbon dioxide removal unit.

In other arrangements there is no step of recovering carbon dioxide from the hydrogen-enriched synthesis gas stream upstream of the purification unit. This arrangement is more straightforward from a retrofit perspective because no carbon dioxide removal unit has to be installed between the synthesis gas water gas shift unit and the purification unit. The plant can be run while the OTU is being installed which minimises plant downtime.

A further advantage of this arrangement is that it may allow the tail gas stream to be fed to the ATR or POX reactor within the tail gas treatment unit at higher pressure compared to when a carbon dioxide removal unit is present. Operating the tail gas reforming unit at higher pressures is advantageous as it reduces the size of the unit.

### Purification Unit

The purification unit may suitably operate by means of pressure swing absorption, temperature swing absorption, membrane separation, or cryogenic separation. Such systems are commercially available. The purification unit is preferably a pressure swing adsorption unit. Such units comprise regenerable porous adsorbent materials that selectively trap gases other than hydrogen and thereby purify it. The purification unit produces a pure hydrogen stream preferably with a purity greater than 99.5% vol, more preferably greater than 99.9% vol, which may be compressed and used in downstream power or heating process, for example, by using it as fuel in a gas turbine (GT) or by injection into a domestic or industrial networked gas piping system. The pure hydrogen may also be used in a downstream chemical synthesis process. Thus, the pure hydrogen stream may be used to produce ammonia by reaction with nitrogen in an ammonia synthesis unit. Alternatively, the pure hydrogen may be used with a carbon dioxide-containing gas to manufacture methanol in a methanol production unit. Alternatively, the pure hydrogen may be used with a carbon-monoxide containing gas to synthesise hydrocarbons in a Fischer-Tropsch production unit. Any known ammonia, methanol or Fischer-Tropsch production technology may be used.

Alternatively, the hydrogen may be used to upgrade hydrocarbons, e.g. by hydro-treating or hydro-cracking hydrocarbons in a hydrocarbon refinery, or in any other process where pure hydrogen may be used. Compression may be accomplished using an electrically driven compressor powered by renewable electricity.

A portion of the pure hydrogen may be compressed if necessary and recycled to the hydrocarbon feed if desired for desulphurisation and to reduce the potential for carbon formation on the catalyst in the fired steam reformer.

The hydrogen purification unit desirably operates with continual separation of the tail gas. The tail contains methane and may contain carbon monoxide. The tail gas composition depends on the extent of the purification of the hydrogen enriched synthesis gas. For example, without an upstream carbon dioxide removal step, the tail gas stream may comprise 15-40% vol hydrogen, with the balance comprising methane, carbon monoxide, carbon dioxide and inert gases. For example, the methane content may be in the range 10-35% vol, the carbon monoxide content may be <20% vol, preferably <1% vol, and the carbon dioxide content may be in the range 40-60% vol. With an upstream carbon dioxide removal step, the tail gas may comprise 40-60% vol hydrogen or 60-80% vol hydrogen, depending, respectively, on the whether the hydrocarbon reforming unit consists of a fired steam reformer or also includes an autothermal reformer.

### Retrofit Method

The retrofit method involves installing a tail gas treatment unit into an existing hydrogen production unit comprising a fired steam reformer, a synthesis gas water-gas shift unit and a purification unit. The tail gas treatment unit comprises a partial oxidation reactor or a tail gas reforming unit configured to provide a partially-oxidised or reformed tail gas, a water-gas shift unit comprising one or more water-gas shift reaction vessels configured to provide a hydrogen-enriched gas, a carbon dioxide removal unit configured to provide a hydrogen stream and a carbon dioxide stream, and means to convey at least a portion of the hydrogen stream to the fired steam reformer as a fuel.

In one embodiment the retrofit method involves installing an autothermal reformer within the hydrocarbon reforming unit, wherein the autothermal reformer is arranged to be fed with a reformed gas from the fired steam reformer and an oxygen containing gas to generate the synthesis gas. The benefit of this arrangement is that, because the autothermal reformer is present to carry out additional reforming on the reformed gas produced by the fired steam reformer, a higher methane slip through the fired steam reformer can be tolerated. In turn, this means that the throughput through the fired steam reformer can be increased. In this arrangement it may be preferable to mix a portion of the hydrocarbon feedstock with the reformed gas from the fired steam reformer upstream of the autothermal reformer, i.e. such that a portion of the hydrocarbon feedstock bypasses the installed autothermal reformer. The retrofit method may therefore include installing means to mix a portion of the hydrocarbon feedstock with the reformed gas from the fired steam reformer upstream of the autothermal reformer.

In one embodiment the method includes installing a fired heater to heat one or more feeds to the tail gas treatment unit using a portion of the hydrogen stream. The fired heater may be fueled entirely by the hydrogen stream, or by a mixture of the hydrogen stream and a supplemental fuel.

### Tail Gas Treatment Unit

In the present invention, at least a portion of the tail gas stream is subjected to partial oxidation or reforming in a tail gas reforming unit to form a partially-oxidised or reformed tail gas, followed by one or more stages of water gas shift of the partially-oxidised or reformed tail gas in a tail gas water-gas shift unit to form a hydrogen-enriched gas, and a step of carbon dioxide removal from the hydrogen-enriched gas in a tail gas carbon dioxide removal unit to form a hydrogen stream and a carbon dioxide stream, the carbon dioxide stream is recovered and at least a portion of the hydrogen stream is fed to the fired steam reformer as a fuel.

The feed to the tail gas treatment unit may be supplemented with a portion of the hydrocarbon feedstock and/or another hydrocarbon-containing gas stream, such as a refinery off-gas. This increases the flexibility of the tail gas treatment unit, ensures there is sufficient hydrogen for firing the fired steam reformer, and is advantageous during start-up of the process. If desired, upstream of the tail gas treatment unit, the portion of the hydrocarbon feedstock used to supplement the feed may be pre-reformed using an adiabatic pre-reformer as described above.

The portion of the tail gas fed to the partial oxidation reactor or the tail gas reforming unit in the tail gas treatment unit may be up to 100% by volume of the tail gas.

In a preferred embodiment one or more feeds to the tail gas treatment unit are heated using a fired heater that is fired by a portion of the hydrogen stream generated by the tail gas treatment unit.

It is preferred that the feed to the partial oxidation reactor or a tail gas reforming unit is supplied at a pressure of 10-30 barg, preferably 15-30 barg. The feed may require compression upstream of the partial oxidation reactor or tail gas reforming unit. Although compression consumes energy, this may be outweighed by the greater efficiency of carbon dioxide removal in the carbon dioxide removal unit operates at higher pressure.

In a preferred embodiment the tail gas reforming unit in the tail gas treatment comprises an autothermal reformer. The scale of the autothermal reformer in the tail gas reforming unit may be the same or different to any such reformer in the hydrocarbon reforming unit, but the design, catalyst and operation are conveniently the same as described above. The portion of the tail gas fed to the autothermal reformer may be compressed, if necessary, to a pressure in the range of 10-50 bar abs and heated, if necessary, to a temperature of 350-650° C. prior to being fed to the autothermal reformer. Heating of the portion of the tail gas may be performed using a fired heater that uses a portion of the hydrogen stream produced by the tail gas treatment unit as fuel. The oxygen-containing gas fed to the partial oxidation reactor or autothermal reformer in the tail gas reforming unit may be air, oxygen enriched air or oxygen gas as an oxidant, but is preferably air. The oxygen-containing gas may be the same or different from that used in any autothermal reformer in the hydrocarbon reforming unit, although it is convenient to use air because the resulting hydrogen stream is used as fuel and the presence of nitrogen may be tolerated. The use of air avoids the need to uprate or add a further air separation unit where an existing process is being retrofitted with a tail gas treatment unit. Steam may be added to the oxygen-containing gas and/or the tail gas portion. The tail gas is autothermally reformed in the autothermal reformer to produce a reformed tail gas. The reformed tail gas will comprise hydrogen, steam, carbon monoxide and carbon dioxide. Argon and nitrogen may also be present if air rather than oxygen is fed to the autothermal reformer.

A partial oxidation reactor may alternatively be used to convert the portion of the tail gas into a partially oxidised tail gas by partial oxidation using a sub-stoichiometric amount of oxygen. Partial oxidation reactors, or POX reactors, are known and typically comprise a vessel to which the feed and an oxygen-containing gas are fed via a burner, analogous to that used in an autothermal reformer, disposed above a reaction chamber in which the partial combustion reactions take place. Unlike an autothermal reformer, a catalyst is not present in the vessel. The oxygen-containing gas may be the same or different from that used in any autothermal reformer in the hydrocarbon reforming unit, although it is convenient to use air for the reasons set out above for the autothermal reformer. The combustion temperature may be about 1300° C., or higher. Steam may be added to the feed and/or the oxygen to lower the combustion temperature and reduce soot formation. The idealised formula for this reaction applied to methane in the feed is as follows:

CH₄+½O₂→CO+2H₂

However, yields are below stoichiometric because part of the feed is fully combusted, and the problem of soot formation requires generally increased amounts of steam or oxygen, and so the tail gas treatment unit preferably comprises an autothermal reformer rather than a partial oxidation reactor.

The exit temperature from a tail gas autothermal reformer or tail gas partial oxidation reactor may be in the range 800-1300° C. It is desirable therefore to adjust the temperature of the partially oxidised or reformed tail gas upstream of the tail gas water gas shift unit. This may conveniently be done by recovering heat in a heat recovery unit, including the generation of steam in one or more boilers, which steam may usefully be used in heating or in power generation using a steam turbine. In some embodiments, steam generated by the heat recovery from the tail gas reforming unit may be used to supplement the steam addition to the hydrocarbon feedstock and/or tail gas upstream of the respective reforming units. Extra steam generated in the tail gas treatment unit may be used to provide process heating or motive power for compressors or for generating electricity.

It is preferred that the outlet gases from the ATR or POX reactor are cooled to generate superheated steam. The superheated steam may then be used to generate electricity, for example by expanding the superheated steam using a steam turbine with a connected alternator. This arrangement reduces the electricity import to the process.

### Tail Gas Water-Gas Shift Unit

The partially-oxidised or reformed tail gas is subjected to one or more stages of water-gas shift in a tail gas water-gas shift unit. Steam is necessary for the water-gas shift reaction. If insufficient steam is present in the partially-oxidised or reformed tail gas, steam may be added upstream of the tail gas water gas shift unit, e.g. by direct addition.

The partially-oxidised or reformed tail gas may be passed through one or more beds of water-gas shift catalyst in one or more shift vessels to generate a hydrogen-enriched, or “shifted”, tail gas in the same manner as used in the synthesis gas water-gas shift unit described above. Therefore, the one or more water-gas shift stages applied to the tail gas may include stages of high-temperature shift, medium-temperature shift, isothermal shift and low-temperature shift as described above. Whereas one or more adiabatic water-gas shift stages may be employed, such as a high-temperature shift stage, optionally followed by a low-temperature shift stage, the partially-oxidised or reformed tail gas may be subjected to a stage of isothermal water-gas shift in a shift vessel in which the catalyst is cooled, optionally followed by one or more adiabatic medium- or low-temperature water-gas shift stages in un-cooled vessels as described above. Whereas the term “isothermal” is used to describe a cooled shift converter, there may be a small increase in temperature of the gas between inlet and outlet, so that the temperature of the hydrogen-enriched reformed gas stream at the exit of the isothermal shift converter may be between 1 and 25 degrees Celsius higher than the inlet temperature. The coolant conveniently may be water under pressure such that partial, or complete, boiling takes place. The water can be in tubes surrounded by catalyst or vice versa. The resulting steam can be used in the process, for example, to drive a turbine, e.g. for electrical power, or to provide process steam for supply to the process. In some embodiments, steam generated by the isothermal shift stage may be used to supplement the steam addition to the hydrocarbon feedstock upstream of the hydrocarbon reforming unit and/or tail gas upstream of the tail gas treatment unit. This improves the efficiency of the process and enables the desired steam to carbon ratio to be achieved at low cost.

Following the one or more shift stages, the hydrogen-enriched tail gas is desirably cooled to a temperature below the dew point so that the steam condenses in a similar manner to that described for the synthesis gas upstream of the purification unit. This forms a de-watered hydrogen-enriched tail gas. The liquid water condensate may be separated using one or more, gas-liquid separators, which may have one or more further cooling stages between them. Any coolant may be used. Typically cooling of the hydrogen-enriched tail gas may be provided by boiling water under pressure coupled to a steam drum. If desired, cooling may be carried out in heat exchange with the process condensate. As a result, a stream of heated water, which may be used to supply some or all of the steam required for the hydrocarbon reforming unit and/or the tail gas reforming unit, may be formed. One or more further stages of cooling are desirable. The cooling may be performed in heat exchange in one or more stages using demineralised water, air, or a combination of these. In a preferred embodiment, cooling is performed in heat exchange with one or more liquids used in the downstream CO₂ separation unit. One, two or three stages of condensate separation may be performed. Any condensate not used to generate steam may be sent to water treatment as effluent.

In a preferred embodiment tail gas water-gas shift unit comprises an isothermal shift reactor cooled by boiling water under pressure.

### Tail Gas Carbon Dioxide Removal Unit

In the present invention, preferably after separation of the condensed water, carbon dioxide is separated from the hydrogen-enriched tail gas stream in a carbon dioxide removal unit.

The carbon dioxide removal unit may operate by means of adsorption of carbon dioxide into a solid adsorbent, such as a molecular sieve, for example in a pressure swing absorption (PSA) unit, separation of a hydrogen-rich gas using a hydrogen-permeable membrane, by cryogenic separation of carbon dioxide, or alternatively by absorption of carbon dioxide into a liquid in a physical wash system or a reactive wash system. Solid adsorbent and membrane systems may be used where the amount of tail gas and/or the purity of the hydrogen stream are not high. However, for improved carbon dioxide removal, a wash system, especially a reactive wash system, such as an amine wash system, is preferred. The carbon dioxide may therefore be separated by an acid gas recovery (AGR) process. In the AGR process, a de-watered hydrogen-enriched reformed gas stream (i.e. a de-watered shifted gas) is contacted with a stream of a suitable absorbent liquid, such as an amine, for example monoethanolamine, diethanolamine, methyl diethanolamine and diglycolamine, particularly methyl diethanolamine (MDEA) solution so that the carbon dioxide is absorbed by the liquid to give a laden absorbent liquid and a gas stream having a decreased content of carbon dioxide. The laden absorbent liquid may be regenerated by heating and/or reducing the pressure, to desorb the carbon dioxide and to give a regenerated absorbent liquid, which is then recycled to the carbon dioxide absorption stage. The heating may suitably be provided by steam, hot condensate or another suitable heating medium generated by the process. Because the source of the hydrogen-enriched gas is a tail gas stream, inert substances such as nitrogen and argon may be present. An amine wash carbon dioxide removal unit conveniently leaves these inert gases within the hydrogen gas stream that is fed to the fired steam reformer as fuel, so in this way they may be effectively removed from the process. Alternatively, chilled methanol or a glycol may be used to capture the carbon dioxide in a similar manner as the amine. Carbon dioxide removal units of the types described above are commercially available.

The recovered carbon dioxide is relatively pure and so may be compressed and used for the manufacture of chemicals, purified for use in the food industry, or sent to storage or sequestration or used in enhanced oil recovery (EOR) processes. In cases where the CO₂ is to be compressed for storage, transportation, use in EOR processes or conversion to other chemical products, the CO₂ may be first dried to prevent liquid water present in trace amounts, from condensing. For example, the CO₂ may be dried to a dew point≤10° C. by passing it through a bed of a suitable desiccant, such as a zeolite, or contacting it with a glycol in a glycol drying unit.

Upon the separation of the carbon dioxide, the process provides a hydrogen gas stream. Where a pure oxygen-containing gas stream (i.e. ≥95% vol, preferably ≥98% O₂ vol) is used in the partial oxidation reactor or autothermal reformer in the tail gas reforming unit, the hydrogen stream may comprise 75-99% vol hydrogen, preferably 90-99% vol hydrogen, with the balance comprising one or more of methane, carbon monoxide, carbon dioxide and inert gases. Where air is used in the partial oxidation reactor or autothermal reformer in the tail gas reforming unit, the hydrogen stream may comprise 40-70% vol hydrogen, with the balance comprising mostly nitrogen with minor amounts of one or more of methane, carbon monoxide, carbon dioxide and argon.

Because the hydrogen gas stream is used as a fuel the purity need not be as high as the hydrogen product recovered from the purification unit and so the present invention preferably does not comprise an additional purification unit for the tail gas-derived hydrogen stream. Nevertheless, if desired, a portion of the hydrogen gas stream from the tail gas treatment unit may be fed to the purification unit to increase the production of the purified hydrogen product, or may be blended with the purified hydrogen product to produce a hydrogen product gas.

The fired steam reformer is fired using at least a portion of the hydrogen product produced by the tail gas treatment unit. This offers a potential reduction in CO₂ emissions from an existing process using tail gas and natural gas mixtures as fuel of at least 90% and potentially 95%, or higher. The replacement of the conventional carbon-containing fuel gas may require adjustment of one or more of the burners in the fired steam reformer, or replacement of one or more of the burners. Therefore, where an existing fired reformer is retrofitted with a tail gas treatment unit as described above, the retrofitting method may include installation of new H₂ fuel burners in the fired reformer. In addition, adjustment may be needed in a convection section or heat recovery duct of the fired steam reformer. This may include adding extra burners in the heat recovery duct to satisfy fired reformer heat demand. If one or more fired heaters are installed, these are desirably fired by a portion of the hydrogen product to maintain the advantage of the tail gas treatment unit in decarbonising the process. Furthermore, where the use of the hydrogen stream as fuel in the fired steam reformer results is less heat recovery in the convection section or heat recovery duct of the fired reformer, then a fired heater in the tail gas treatment unit using a portion of the hydrogen stream as fuel advantageously may be used to make up the balance. Accordingly, the invention includes providing the tail gas treatment unit with a fired heater to ensure the heating demand of overall plant is satisfied.

In order to minimise emissions of nitrogen oxides from the fired reformer and any fired heater used in the tail gas treatment unit, it is desirable that either, or both, have flue-gas purification unit installed that removes or decomposes the nitrogen oxides that may be formed by the combustion of the hydrogen stream with air. Such “de-Nox” purification units are known and are commercially available. Alternatively, or in addition, the burners used may be adapted specifically to produce low levels of nitrogen oxides or replaced with burners designed to produce low levels of nitrogen oxides.

The tail gas treatment unit may be fed by more than one hydrogen production units and may also returns the hydrogen stream to more than one hydrocarbon reforming unit. The tail gas treatment unit may therefore be operatively connected to two or more hydrogen production units each having a hydrocarbon reforming unit containing a fired reformer. Furthermore, in the present invention, it is not necessary that the tail gas treatment unit is located adjacent the hydrogen production unit.

### DESCRIPTION OF THE FIGURES

The invention will now be further illustrated by reference to the Figures in which:

FIG. 1 is a flow sheet depicting a hydrogen production unit according to one embodiment of the invention comprising a fired steam reformer and a tail gas treatment unit, with hydrogen product supplied as fuel for the fired steam reformer;

FIG. 2 is a flow sheet depicting one embodiment of a tail gas treatment unit suitable for use in the present invention.

It will be understood by those skilled in the art that the drawings are diagrammatic and that further items of equipment such as feedstock drums, pumps, vacuum pumps, compressors, gas recycling compressors, temperature sensors, pressure sensors, pressure relief valves, control valves, flow controllers, level controllers, holding tanks, storage tanks and the like may be required in a commercial plant. Provision of such ancillary equipment forms no part of the present invention and is in accordance with conventional chemical engineering practice.

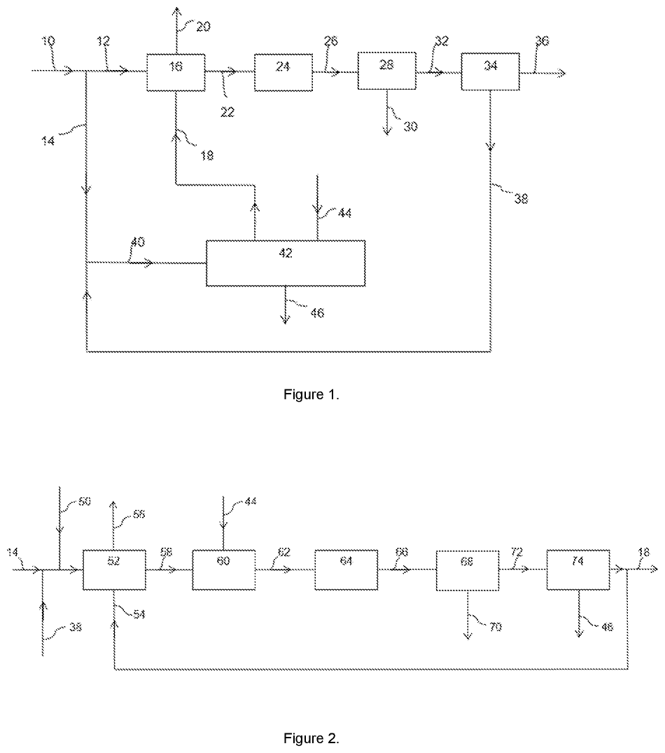

In FIG. 1, a natural gas feed supplied by line 10 is divided into a first portion 12 and a second portion 14. The first portion 12 is combined with steam using a saturator or by direct steam addition (not shown), optionally subjected to a step of adiabatic pre-reforming (not shown) and fed to a hydrocarbon reforming unit comprising a fired steam reformer 16 containing a plurality of externally heated catalyst-filled reformer tubes. The fired steam reformer is heated by combustion of a fuel supplied by line 18 and generates a flue gas emitted via line 20. Steam reforming reactions take place as the natural gas and steam mixture passes over the steam reforming catalyst in the reformer tubes to generate a crude synthesis gas comprising hydrogen, carbon monoxide, carbon dioxide, unreacted methane and steam. The synthesis gas is recovered from the fired steam reformer 16 via line 22 and cooled in a water heat boiler (not shown) to an inlet temperature for the syngas water gas shift unit 24. The syngas water gas shift unit 24 comprises high temperature shift stage optionally followed by a low temperature shift stage, that converts carbon monoxide to carbon dioxide and forms a hydrogen-enriched syngas. The hydrogen-enriched syngas is fed from the unit 24 via line 26 to a heat recovery unit 28, in which it is cooled in heat exchange with water and one or more process feeds or air, to below the dew point such that the steam condenses. Process condensate is separated from the gas using one or more gas-liquid separators and recovered from the heat recovery unit 28 via line 30 and used as a source of steam used in the steam reforming stages of the process. A dewatered hydrogen-enriched synthesis gas is fed from the heat recovery unit 28 via line 32 to a purification unit 34. The purification unit operates by pressure swing absorption to provide a purified hydrogen product stream, which is recovered via line 36, and a tail gas stream, which is recovered via line 38.

The tail gas 38 is combined with the second portion of hydrocarbon in line 14 and the combined gas is fed via line 40 to a tail gas treatment unit 42.

In the tail gas treatment unit 42, further described by reference to FIG. 2, the combined tail gas stream and natural gas mixture are heated and passed to a tail gas reforming unit in which it is subjected to autothermal reforming with an oxygen-containing gas, such as air, oxygen-enriched air or oxygen gas fed via line 44 in a tail gas autothermal reformer, then heat recovery and optional condensate separation in a heat recovery unit, followed by water-gas shift in a water gas shift unit, and finally CO₂ removal in a carbon dioxide removal unit. The CO₂ removal unit generates a carbon dioxide stream, which is recovered from the tail gas treatment unit 42 by line 46, optionally purified, compressed, and sent for storage or sequestration. The removal of CO₂ generates a hydrogen stream, which is recovered from the tail gas treatment unit 42 and fed via line 18 as fuel to the fired steam reformer 16, thereby generating a low CO₂ flue gas 20.

In FIG. 2, one embodiment of a suitable tail gas treatment unit is depicted. The second portion 14 of the natural gas feed, optionally after a step of adiabatic pre-reforming, is combined with the tail gas 38. Steam is optionally added from line 50 and the resulting mixture heated in a fired heater 52. The fired heater 52 is heated by combustion of a hydrogen stream 54 with air to produce a combustion flue gas 56.

The heated gas mixture is fed from the fired heater 52 via line 58 to a tail gas reforming unit comprising a tail gas autothermal reformer 60, where it is partially combusted in a burner with the oxygen-containing gas fed via line 44. The oxygen containing gas fed to the tail gas autothermal reformer 60 may be air. The partially combusted gas is then adiabatically steam reformed in a bed of steam reforming catalyst disposed beneath the burner within the autothermal reformer 60. The autothermal reforming generates a reformed tail gas comprising hydrogen, carbon monoxide, carbon dioxide and steam, which is fed via line 62 to a heat recovery unit (not shown) to reduce the temperature. In one arrangement, the cooling reduces the temperature of the reformed tail gas to between 20° and 300° C. and above the dew point, such that the cooled reformed gas may be fed directly, after optional steam addition, to a water-gas shift unit 64.

The water gas shift unit 64, comprises an adiabatic high temperature shift vessel containing a high temperature shift catalyst, alone or in combination with a medium-temperature shift vessel containing a medium temperature shift catalyst and/or a low temperature shift vessel containing a low-temperature shift catalyst, with temperature adjustment after the or each water gas shift vessel, or the water gas shift unit may comprise an isothermal shift vessel containing an isothermal shift catalyst cooled by boiling water under pressure. In the water gas shift unit 64, the reformed tail gas becomes enriched in hydrogen by the water-gas shift reaction to form a hydrogen-enriched tail gas stream.

The hydrogen-enriched reformed gas recovered from the water gas shift unit 64 is then fed via line 66 to a heat recovery unit 68 that cools the hydrogen-enriched gas to below the dew point such that remaining steam condenses. The heat recovery unit 68 comprises one of more gas liquid separators that separate the condensate, which is recovered via line 70 for use in the process.

The resulting dewatered hydrogen-enriched tail gas is fed from the heat recovery unit 68 via line 72 to a carbon dioxide removal unit 74 operating my means of an amine wash, which absorbs carbon dioxide from the dewatered hydrogen-enriched tail gas to produce a hydrogen stream. The hydrogen stream is recovered from the carbon dioxide removal unit 74 and divided between the portion 54 fed to the fired heater 52 and the portion 18 fed to the fired steam reformer 16 of FIG. 1. Regeneration of the amine absorbent in the carbon dioxide removal unit 74 generates a carbon dioxide stream, which is recovered from the unit 74 via line 46. The recovered carbon dioxide may be compressed and sent for sequestration.

### EXAMPLE

The invention will be further described by reference to the following calculated examples prepared using conventional process modelling software suitable for hydrogen processes.

Example 1 is an example of a flowsheet according to FIG. 1 using the tail gas treatment unit of FIG. 2, designed to produce 87.5 tonnes/day hydrogen. The process conditions and compositions of the various streams are set out below.

| | | Stream Number | | | | |
|---|---|---|---|---|---|---|
| | | 14 | 18 | 20 | 32 | 36 |
| Temperature | ° C. | 40 | 40 | 1026 | 65 | 40 |
| Pressure | bar a | 42.0 | 1.70 | 1.01 | 30.9 | 30.6 |
| Mass Flow | tonne/h | 2.800 | 23.30 | 100.5 | 31.44 | 3.646 |
| Molecular Weight | | 16.82 | 13.24 | 25.53 | 11.03 | 2.02 |
| Composition | mol % | | | | | |
| Water | | — | 0.51 | 25.86 | 0.92 | — |
| Hydrogen | | — | 56.44 | — | 72.08 | 100.00 |
| Carbon Monoxide | | — | 0.34 | — | 0.42 | — |
| Carbon Dioxide | | 0.36 | 0.05 | 0.37 | 17.84 | — |
| Nitrogen | | 1.25 | 42.21 | 72.72 | 0.33 | — |
| Methane | | 95.90 | 0.45 | — | 8.43 | — |
| Ethane | | 1.62 | — | — | — | — |
| Propane | | 0.59 | — | — | — | — |
| Butane | | 0.21 | — | — | — | — |
| Pentane | | 0.04 | — | — | — | — |
| Oxygen | | — | — | 1.05 | — | — |

| | | Stream Number | | | | |
|---|---|---|---|---|---|---|
| | | 38 | 44 | 46 | 50 | 58 |
| Temperature | ° C. | 40 | 10 | 5 | 235 | 600 |
| Pressure | bar a | 1.70 | 1.01 | 36.0 | 30.0 | 19.0 |
| Mass Flow | tonne/h | 27.80 | 35.74 | 40.08 | 18.01 | 48.61 |
| Molecular Weight | | 26.66 | 28.84 | 43.95 | 18.02 | 22.00 |
| Composition | mol % | | | | | |
| Water | | 2.51 | — | 0.05 | 100.00 | 46.44 |
| Hydrogen | | 23.65 | — | 0.10 | — | 11.16 |
| Carbon Monoxide | | 1.14 | — | — | — | 0.54 |
| Carbon Dioxide | | 48.77 | — | 99.85 | — | 23.05 |
| Nitrogen | | 0.89 | 79.21 | — | — | 0.51 |
| Methane | | 23.05 | — | — | — | 18.11 |
| Ethane | | — | — | — | — | 0.12 |
| Propane | | — | — | — | — | 0.04 |
| Butane | | — | — | — | — | 0.02 |
| Pentane | | — | — | — | — | — |
| Oxygen | | — | 20.79 | — | — | — |

| | | Stream Number | | | | | |
|---|---|---|---|---|---|---|---|
| | | 62 | 66 | 70 | 72 | 54 | 56 |
| Temperature | ° C. | 850 | 209 | 65 | 65 | 40 | 199 |
| Pressure | bar a | 18.0 | 16.3 | 15.3 | 15.3 | 1.70 | 0.81 |
| Mass Flow | tonne/h | 84.75 | 84.75 | 12.37 | 72.38 | 7.849 | 34.82 |
| Molecular Weight | | 21.12 | 21.12 | 18.04 | 21.75 | 13.24 | 25.61 |
| Composition | mol % | | | | | | |
| Water | | 29.47 | 18.94 | 99.89 | 2.25 | 0.51 | 25.22 |
| Hydrogen | | 22.58 | 33.11 | — | 39.93 | 56.44 | — |
| Carbon Monoxide | | 10.73 | 0.20 | — | 0.24 | 0.34 | — |
| Carbon Dioxide | | 12.22 | 22.75 | 0.11 | 27.42 | 0.05 | 0.36 |
| Nitrogen | | 24.74 | 24.74 | — | 29.84 | 42.21 | 72.88 |
| Methane | | 0.26 | 0.26 | — | 0.32 | 0.45 | — |
| Ethane | | — | — | — | — | — | — |
| Propane | | — | — | — | — | — | — |
| Butane | | — | — | — | — | — | — |
| Pentane | | — | — | — | — | — | — |
| Oxygen | | — | — | — | — | — | 1.53 |

The CO₂ emissions from this process (Example 1) were compared to a comparative process without the tail gas treatment unit. Comparative Example 2 is based in FIG. 1 but without the tail gas treatment unit such that the tail gas 38 is combusted in the fired reformer 16 as in a conventional hydrogen plant.

Example 1 contains the flue gases from both the fired reformer 16 and the fired heater 54.

| | | Comparative |
|---|---|---|
| | Example 1 | Example 2 |
| Flue gas | 20 + 56 | 20 |

| | | | |
|---|---|---|---|
| Temperature | ° C. | 175 | 175 |
| Pressure | bar a | 1.02 | 1.02 |
| Mass Flow | tonne/h | 135 | 131 |
| Molar Flow | kgmole/h | 5295 | 4496 |
| Molecular | | 25.5 | 29.1 |
| Weight | | | |
| Composition | kgmole/h | | |
| Water | | 1361 | 826 |
| Carbon Dioxide | | 20 | 798 |
| Nitrogen | | 3853 | 2819 |
| Oxygen | | 62 | 55 |

The invention therefore provides a total CO₂ reduction of 822 te/day or about 300,000 te/year. This corresponds to a 97.5% reduction in CO₂ emissions.

1. A method for retrofitting a hydrogen production unit comprising:
a hydrocarbon reforming unit comprising a fired steam reformer arranged to be fed with a hydrocarbon feedstock;
a synthesis gas water gas shift unit arranged to be fed with a synthesis gas from the hydrocarbon reforming unit to produce a hydrogen-enriched synthesis gas; and
a purification unit arranged to be fed with a hydrogen-enriched synthesis gas from the synthesis gas water gas shift unit to generate a hydrogen product and a tail gas stream:
wherein in the hydrogen production unit there is no step of recovering carbon dioxide from the hydrogen-enriched synthesis gas stream upstream of the purification unit;
the method comprising installing a tail gas treatment unit comprising:
a partial oxidation reactor or a tail gas reforming unit arranged to accept at least a portion of the tail gas stream from the purification unit and produce a partially-oxidised or reformed tail gas stream;
a tail gas water-gas shift unit arranged to accept a partially-oxidised or reformed tail gas stream from the partial oxidation reactor or a tail gas reforming unit and produce to form a hydrogen-enriched tail gas stream;
a tail gas carbon dioxide removal unit arranged to accept a hydrogen-enriched tail gas stream from the tail gas water-gas shift unit and produce a hydrogen stream,
wherein the tail gas treatment unit is arranged to feed the hydrogen stream to the fired steam reformer as a fuel.

2. The method according to claim 1, wherein the method includes installing an autothermal reformer within the hydrocarbon reforming unit, wherein the autothermal reformer is arranged to be fed with a reformed gas from the fired steam reformer and an oxygen containing gas to generate the synthesis gas.

3. The method according to claim 1, wherein the method includes installing a fired heater to heat one or more feeds to the tail gas treatment unit using a portion of the hydrogen stream.

4-5. (canceled)

6. A process for producing hydrogen comprising the steps of:
(i) reforming a hydrocarbon feedstock in a hydrocarbon reforming unit comprising a fired steam reformer to form a synthesis gas containing hydrogen, carbon monoxide and carbon dioxide;
(ii) subjecting the synthesis gas to one or more stages of water gas shift in a synthesis gas water gas shift unit to convert carbon monoxide to carbon dioxide and form a hydrogen-enriched synthesis gas; and
(iii) treating the hydrogen-enriched synthesis gas in a purification unit to form a purified hydrogen product and tail gas stream containing methane,
wherein there is no step of recovering carbon dioxide from the hydrogen-enriched synthesis gas stream upstream of the purification unit;
wherein at least a portion of the tail gas stream is treated in a tail gas treatment unit by subjecting it to:
partial oxidation in a partial oxidation reactor or autothermal reforming in a tail gas reforming unit to form a partially-oxidised or reformed tail gas, followed by
one or more stages of water gas shift of the partially-oxidised or reformed tail gas in a tail gas water-gas shift unit to form a hydrogen-enriched tail gas, and
a step of carbon dioxide removal from the hydrogen-enriched tail gas in a tail gas carbon dioxide removal unit to form a hydrogen stream and a carbon dioxide stream,
wherein the carbon dioxide stream is recovered and a portion of the hydrogen stream is fed to the fired steam reformer as a fuel.

7. The process according to claim 6, wherein the hydrocarbon reforming unit comprises a fired steam reformer and an autothermal reformer and the process comprises feeding an oxygen containing gas and a reformed gas from the fired steam reformer to the autothermal reformer to generate the synthesis gas.

8. The process according to claim 7, wherein the reformed gas from the fired steam reformer is mixed with a portion of the hydrocarbon feedstock.

9. The process according to claim 6, wherein the hydrogen-enriched synthesis gas is cooled to below the dew point and condensate separated from it upstream of the purification unit.

10-11. (canceled)

12. The process according to claim 6, wherein the tail gas fed to the tail gas treatment unit is supplemented with a portion of the hydrocarbon feed and/or another hydrocarbon-containing gas stream.

13. The process according to claim 6, wherein one or more feeds to the tail gas treatment unit are heated using a fired heater that is fired by a portion of the hydrogen stream.

14. The process according to claim 6, wherein a portion of the hydrogen gas stream is fed to the purification unit or is blended with the purified hydrogen product.

15. The process according to claim 6, wherein the feed to the partial oxidation reactor or a tail gas reforming unit is supplied at a pressure of 10-30 barg.
